(19) United States
(12) Patent Application Publication
(10) Pub. No.: US 2009/0265372 A1
(43) Pub. Date: Oct. 22, 2009

(54) Management of Document Attributes in a Document Managing System

(76) Inventor: Arne Esmann-Jensen, Birkerod (DK)

Correspondence Address: DAY PITNEY LLP, 7 TIMES SQUARE, NEW YORK, NY, 10036-7311, US

(21) Appl. No.: 12/225,497

(22) PCT Filed: Feb. 21, 2007
(86) PCT No.: PCT/DK2007/000079

§ 371 Date: Oct. 2, 2008

(30) Foreign Application Priority Data
Mar. 23, 2006 (DK) PA 2006 00412
Mar. 23, 2006 (DK) PA 2006 00414

(51) Int. Cl. G06F 12/00; G06F 7/00; G06F 12/16

(52) U.S. Cl. 707/102; 707/200; 707/E17.008; 707/E17.044; 707/E17.01

(57) ABSTRACT

The present invention relates to a method of storing attributes describing documents in a document management system software application which is configured to be run on a computer with an operating system and a file system, wherein the documents to be managed are stored in said file system and said documents are described by attributes such as identifiers and properties. The attributes are stored as separate elements attached to said documents. Furthermore, the present invention relates to a document management system software application which is configured to be run on a computer with an operating system and a file system, wherein the document management system is for managing documents stored in said file system, wherein said documents are described by attributes such as identifiers and properties. The document management system is configured to handle document attributes being separately and directly attached to said documents.

The present invention relates to a method of storing attributes describing documents in a document handling system and a document management system software application.

### BACKGROUND

The purpose of a document management system, DMS, is to create a controlled process of managing documents. The documents are stored in document repository either directly as ordinary files in a file system or as entities in a database. In either storage way it is possible to control the process of managing the documents in the document repository.

Document management systems in addition commonly provide storage and retrieval of electronic documents, e.g. search for documents and maintenance of document revision history. The documents are in the form of electronic documents such as word processor files, spreadsheet files, drawing files and the like.

U.S. Pat. No. 6,801,902 B1 discloses a document management system which is implemented on a computer system by means of a peripheral driver. Properties of individual documents are stored in a database, and the documents themselves are stored either in the database or directly as different files in a file system. The peripheral driver converts commands received from an operating system or from different application programs into corresponding commands to the database and reversely converts commands received from the database or database outputs into corresponding operating system or application program commands. Thereby, the document attributes (and the documents) appear to be filed in a conventional file system although they are filed in the database. Consequently, the operating system or an application program is capable of directly accessing the documents and the document attributes via the (single) peripheral driver.

A problem with the known DMS, as e.g. the one described above, is that when searching for documents based on their attributes, initially the attributes need to be found in the database and thereafter the documents described by the attributes is to be found based on a link from the attribute to the document. This method has a number of disadvantages, and some of these disadvantages are that the link or the attribute may be lost, e.g. because the documents are present on a different system. Further, the search for attributes, identifying a link and finally finding the linked document is a cumbersome process requiring processing power of the DMS. Further, when handling a large number of linked attributes and documents the search for specific documents based on the attributes can be quite time consuming. Another problem is that a system based on a link between a database of attributes and documents requires fairly complex software in order to handle the linking and the database with attributes. A further problem is that when a document is moved from one system to another the attributes could be lost unless a specific functionality is activated which makes sure that the attribute is copied to a database in the new system. Furthermore, the database could be accidentally deleted or the storing unit on which the database is stored could be damaged, and as a result the attributes for all documents would be lost. Further, the linking requires communication with a database when reading/writing attributes to documents, which is both time consuming and resource demanding.

Another way of handling the defining attributes describing a document could be to place the attribute inside the document, e.g. making the attributes an integrated part of a Word document. A problem with this method is that when searching for documents based on their attributes it is necessary to first open the document to identify the content of the document. Disadvantages of this are that it requires software which is able to handle the file type of the document. Further, when making searches in a large collection of different document types it can be quite time consuming to make searches since all documents have to be opened to identify their attributes. Further, not all document formats provide additional space for adding attributes and if they do each format is designed differently which makes it a complex procedure to read the attributes.

Document management systems in addition commonly provide storage and retrieval of electronic documents, for instance search for documents and maintenance of document revision history. This is often done by using attributes related to the documents where the DMS is able to create, edit, delete and search the attributes related to the documents. The attributes could for instance be the name of the author of the document, a summary of the document content, a reference number connected to the document, the document's revision history etc.

When a user handles the documents using a document management system he or she often needs to edit the attributes, and this is normally a cumbersome process because the document initially needs to be identified using DMS explorer, and when the document attributes to be edited have been identified the document is selected and opened in a specific program in which the attributes can be edited. This is both resource and time demanding. Further, it can be difficult for the user of the DMS to maintain an overview of the documents in the DMS, while editing the attributes.

### SUMMARY OF THE INVENTION

It is therefore an object of the present invention to find a solution to the above-mentioned problems.

This is obtained by a method of storing attributes describing documents in a document management system software application which is configured to be run on a computer with an operating system and a file system, wherein the documents to be managed are stored in said file system and said documents are described by attributes such as identifiers and properties, wherein the attributes are stored as separate elements attached to said documents.

Thereby attributes can be accessed, read and written to documents in DMS without needing access to the actual document. Further, since the attributes are attached to the documents they are accessible when the actual document is identified in the file system, and there is no need to search for the attributes using a separate algorithm. A further advantage is that when attributes are attached to documents according to the invention it is easier to backup, recover and export the DMS.

In an embodiment the file system is configured to maintain a master file table of electronic files stored by means of the file system; said electronic files comprising a primary data stream and an alternate data stream; said electronic files comprising documents, said storing of said attributes is performed by using said alternate data stream as a repository.

This is an advantageous way of attaching attributes since the data stream is already attached to the document.

In an embodiment the file system is the New Technology File System, NTFS, manufactured by Microsoft Corporation®.

In an embodiment the operating system is a Windows operating system manufactured by Microsoft Corporation®.

In another embodiment of the document management system software application, the attributes are stored as separate elements attached to said documents and wherein it is the attached attributes that can be edited from said second part of said editing interface. This is a simple way of editing attributes without requiring opening the actual document for editing its attributes.

In another embodiment of the document management system software application the file system is configured to maintain a master file table of electronic files stored by means of the file system; said electronic files comprising a primary data stream and an alternate data stream; said electronic files comprising documents; said storing of said attributes is performed by using said alternate data stream as a repository and wherein it is the attributes in said alternate data stream that can be edited from said second part of said editing interface. Thereby existing and already attached data space is used for entering attributes and they are easily editable.

In another embodiment of the document management system software application, the attributes relating to said documents are updated immediately after editing the attribute from said second part of said editing interface. Thereby it is ensured that the attributes are always updated, which can be an advantage when more than one user is working on the same DMS, because it ensures that it is always the updated attributes that are presented to the user.

In another embodiment of the document management system software application, the attributes relating to said documents are updated periodically at predefined time intervals after editing the attributes from said second part of said editing interface. Thereby fewer resources are required since an update is not required each time an attribute is edited.

In an embodiment the attributes are attached to the documents by encapsulating the document and the attributes in a single file. In an embodiment the file is a XML file.

In an embodiment the attributes are attached to said document as a separate file by a mapping in the file system.

The present invention further relates to a document management system software application which is configured to be run on a computer with an operating system and a file system, wherein the document management system is for managing documents stored in said file system, wherein said documents are described by attributes such as identifiers and properties. The document management system is configured to handle document attributes being separately and directly attached to said documents. In an embodiment the file system is the New Technology File System, NTFS, manufactured by Microsoft Corporation®. In an embodiment the operating system is a Windows operating system manufactured by Microsoft Corporation®.

In one embodiment of the document management system software application, the document management system comprises an editing interface comprising a first part for viewing the document attributes of the documents handled by the document management system and selecting a document and a second part for editing attributes of said selected document.

Thereby the user has an overview of the contents of the DMS while editing the attributes, which makes it both easier to ensure the correct edited attribute value and faster to edit the attributes while going through the content of the DMS. A further advantage is that the attributes of the content can easily be edited without strict requirements to specific software compatible with the document to which the attributes are linked. Further, the solution requires less resources from the hardware on which the DMS is running.

In another embodiment of the document management system software application, the editing interface further comprises a third part for searching for documents in said document managing system based on said related attributes. Thereby a complete control is obtained where attributes can be searched, selected and edited from the same interface.

### BRIEF DESCRIPTION OF THE FIGURES

In the following a detailed description of the invention will be given with reference to the drawings in which,

FIG. 1 illustrates a document management system according to prior art for electronic documents implemented on a computer,

FIG. 2 illustrates another prior art method of adding extra attributes to a document stored in a document repository,

FIG. 3 illustrates an embodiment of the present invention,

FIGS. 4a-4c illustrate how the additional attributes could be added to a file stored on a storing device,

FIG. 5 illustrates an embodiment of the present invention where the attributes are attached in a NTFS file system,

FIG. 6 illustrates an embodiment of the present invention where the attributes are attached in a new capsule file,

FIG. 7 illustrates an embodiment where the attributes attach as a separate file,

FIG. 8 illustrates a method of how the DMS could add additional attributes to a document stored in a document repository,

FIG. 9 illustrates a method of how a DMS could read and display the additional attributes associated to a document stored in a document repository,

FIG. 10 illustrates how the method described in FIGS. 6 and 7 could be implemented in a document management system.

FIG. 11 illustrates an embodiment of the editing interface according to the present invention.

FIG. 12 illustrates a flow diagram of the editing method

### DETAILED DESCRIPTION

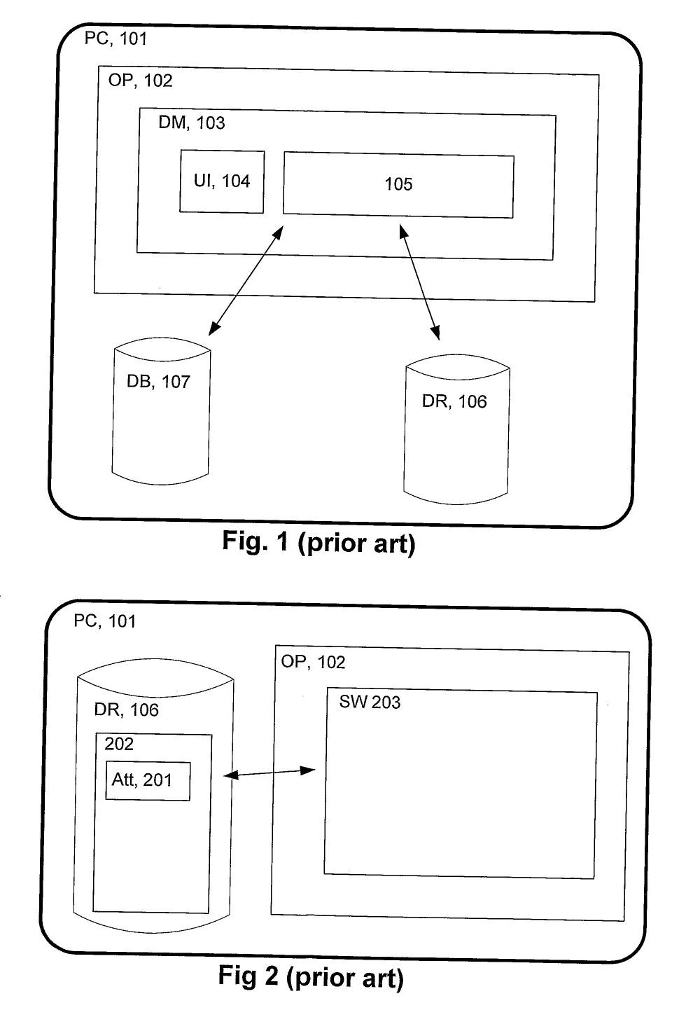

FIG. 1 illustrates a document management system according to prior art for electronic documents implemented on a computer (101). The computer is typically controlled by an operating system (102) which takes care of data handling, software execution and handling of devices like data storage, disk players, input devices, screens, printers, etc. The document management system (103) is typically implemented as a software program running on top of the operating system (102). The document management system comprises a user interface (104) and software routines (105) which execute the user's instructions. The document management system makes it possible for the user to manage electronic documents stored in a document repository (106). In order to manage the documents the user often needs to add different attributes to the documents; this could e.g. be a small description of the document content, the author of the document, a reference number, etc. The document management system stores the attributes in a database (107) together with a link which connects the additional attributes to the correct file. The consequence is that the document management system stores the additional attributes in a database and therefore always has to connect to the database in order to show or edit the attributes. Furthermore, the document management system needs to update the link that links the attributes and the file every time the file is moved or altered. This link could easily by destroyed and thereby become invalid as another software application or the operating system could move the file without updating the database.

FIG. 2 illustrates another way of adding extra attributes (201) to a document (202) stored in a document repository (106). In this implementation the extra attributes are added to and stored as parts of the document by the software application (203) using the document. A major drawback of this implementation is that the user needs the particular software program in order to read and edit the additional attributes, and furthermore it is difficult for the user to perform a search in the additional attributes, especially if the documents that should be included in the search are of different types handled by different software applications.

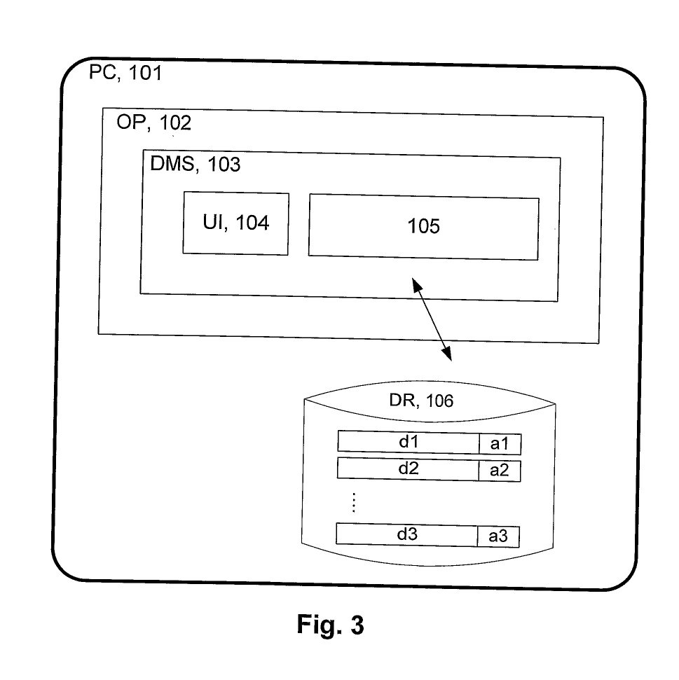

FIG. 3 illustrates an embodiment of the present invention. The document management system (103) for electronic documents is implemented in a computer (101). The computer is controlled by an operating system (102) that takes care of data handling, software execution and handling of devices like data storage, disk players, input devices, screens, printers, etc. The document management system (103) is implemented as a software application running on top of the operating system (102). The document management system comprises a user interface (104) and software routines (105) that execute the user's instructions. The document management system makes it possible for the user to manage electronic documents (d1, d2, d3) stored in a document repository (106). The user is able to attach additional attributes (a1, a2, a3) to each document, and the software routines are programmed to store the attributes (a1, a2, a3) as additional information attached to the document. The attributes are attached as an extra part to the document and the operating system would therefore recognize the document and the additional attributes as one file. The result is that the attributes would always be moved together with the document if the document is moved to another document repository, and the DMS would therefore always be able to access the attributes when handling a document. Furthermore, the DMS is able to perform a search defined by the user in the additional attributes.

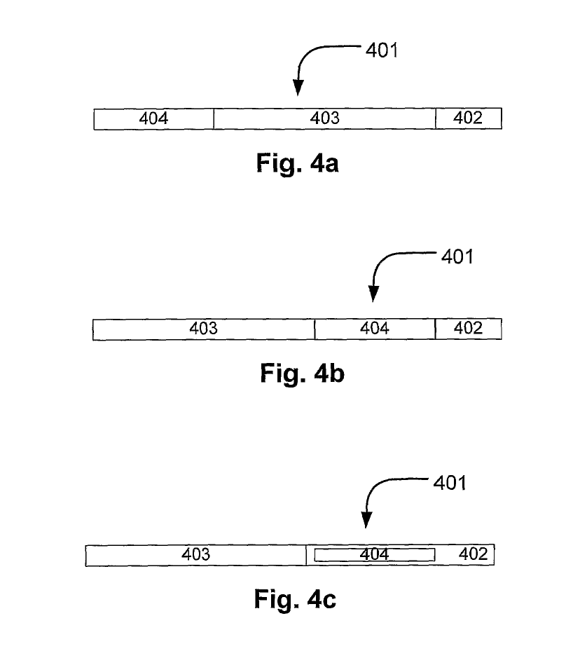

FIGS. 4a-4c illustrate how the additional attributes could be attached to a file stored on a storing device. The file is stored as a bit-stream (401) on a storing device. The bit stream comprises a header (402) and document content (403). The header includes basic file information such as file name, file type and last date of modification and the operating system uses this basic information to identify and to handle the files stored on a storing device. The document content is stored and used by software application and therefore often stored in formats which need appropriate software applications in order to be created, shown and/or edited. This could e.g. be a text created in a word processor or a picture created in an image processing application.

FIG. 4a illustrates an embodiment where the document management system attaches the additional attributes (404) as a bit stream at the end of the file's bit stream and at the same time updates the basic file information in the header so that the operating system will recognize the header, the document content and the additional attributes as one file. This could e.g. be done by altering the basic information defining the size of the file such that the number defining the file size includes both the document content and the additional attributes.

FIG. 4b illustrates an embodiment where the additional attributes are attached as a bit-stream between the header (402) and the document content (403) in the file's bit-stream (401). The DMS can then read the additional attributes just after reading the header, and a search in the additional attributes can then be performed very quickly.

FIG. 4c illustrates an embodiment where the additional attributes are attached as part of the header. The document management system would still have access to the additional attributes since they are stored in the header and not as a part of the document content.

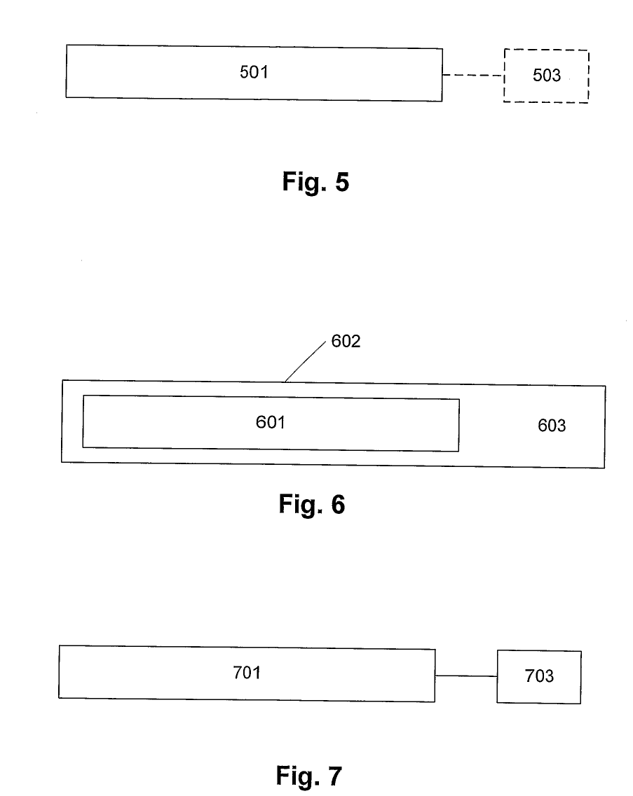

In FIG. 5 an embodiment of the present invention is illustrated where the attributes are attached in a NTFS file system. On a computer using a NTFS file system the additional attributes could be written as an alternate data stream (503) which is attached to a file (501), but not in the file. The NTFS Master File Table which keeps track of all files in a NTFS system contains a list of all data streams that a file contains and their physical location on a storing device. The DMS could in an embodiment be adapted to store the additional attributes in an alternate data stream. The result is that the additional attributes later could be recalled by the DMS, and the DMS could also be adapted to search in the additional attributes. When the DMS processes a file it would use the NTFS Master File Table to find the alternate data stream containing the additional attributes.

In FIG. 6 an embodiment of the present invention is illustrated where a new capsule file is generated containing both the document (601) and the attributes (603). The new file could e.g. be a XML file which is a file type easily readable by most systems, and when accessing documents and their attributes the capsule file is opened and the document and its attributes can be accessed. In order for the document handling program to be able to open the document it is necessary that the document handling program initially recognizes the document type, e.g. based on a naming convention of the XML file. Furthermore, functionality needs to be present for extracting the document from the XML capsule when opening the document for processing it.

FIG. 7 illustrates another example where the attributes are placed in a separate file 703, and where the file is attached to the document 701 by a mapping in the file system. The separate file could e.g. be a XML file.

The above examples of the present invention describe how XML files could be used when attaching attributes to documents in a DMS. Other file types could also be used; requirements of such file types could be that the file type can be opened without requiring a lot of additional system resources, e.g. influencing the file handling time.

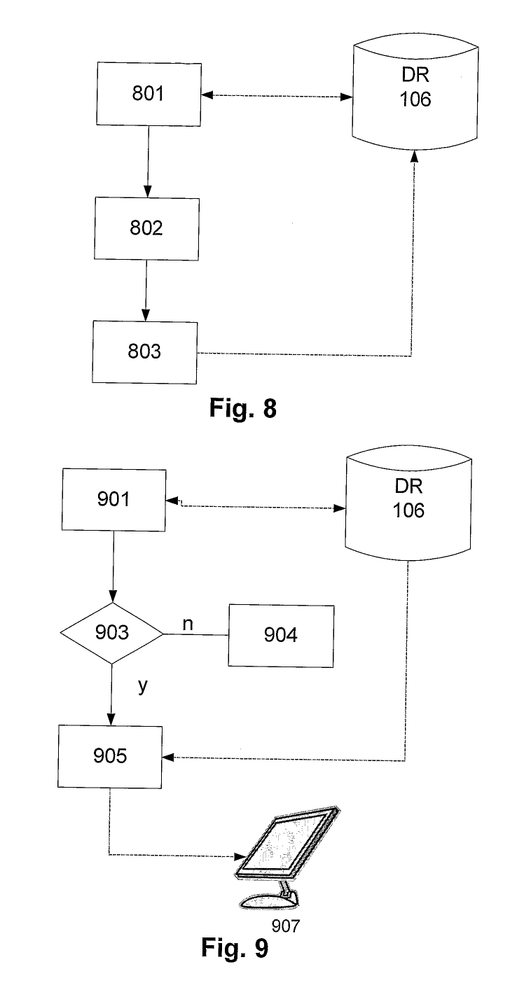

FIG. 8 illustrates a method of how the DMS could add additional attributes to a document stored in a document repository (106). First, the DMS finds/locates a document (801). This could be done by a user browsing the document repository or by an automatic search performed by the DMS. Thereafter the DMS creates the additional attributes (802), typically by letting the user enter the attributes in a form containing the additional attributes used by the DMS. The type and number of additional attributes depends on the purpose for which the DMS is created. Once the additional attributes have been created they are added and stored (803) as parts attached to the document in the document repository (106). Examples of how these attributes could be attached are described above.

FIG. 9 illustrates a method of how a DMS could read and display the additional attributes associated to a document stored in a document repository (106). First, the DMS finds/locates a document (901) in the document repository. Thereafter the DMS investigates if the document has additional attributes associated or not (903). In a NTFS system this is e.g. done by reading an alternate data stream connected to the document and at the same time searching for recognizable data structures defining the attributes. If the document has additional attributes associated, it reads the attributes and displays them to the user (905). In a GUI environment this would typically be done on a screen (907). If no attributes are associated (904) attributes fields are left blank when displaying the attributes to the user.

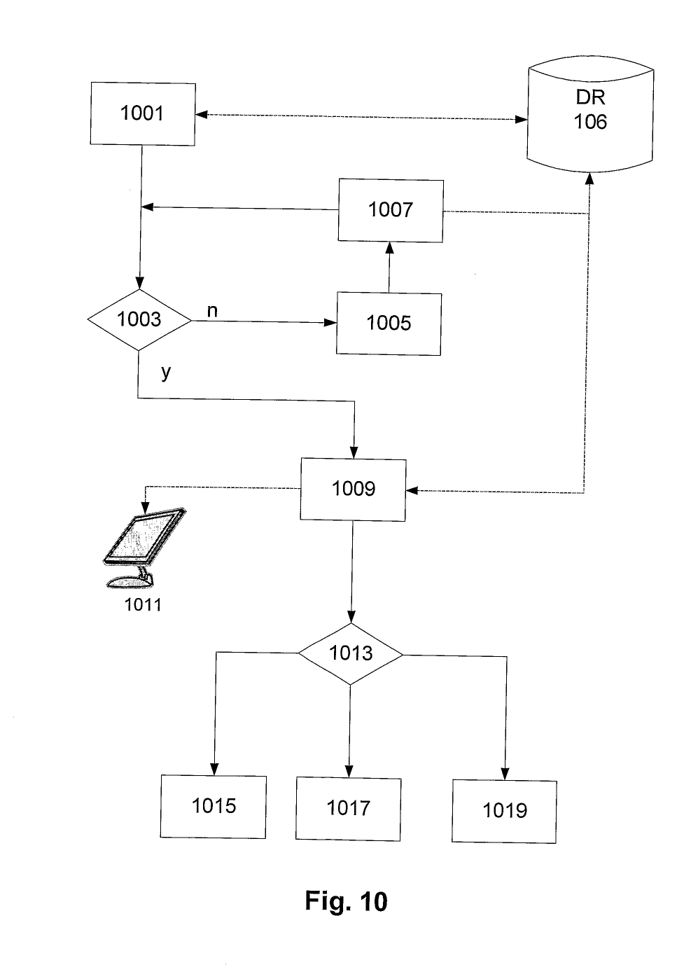

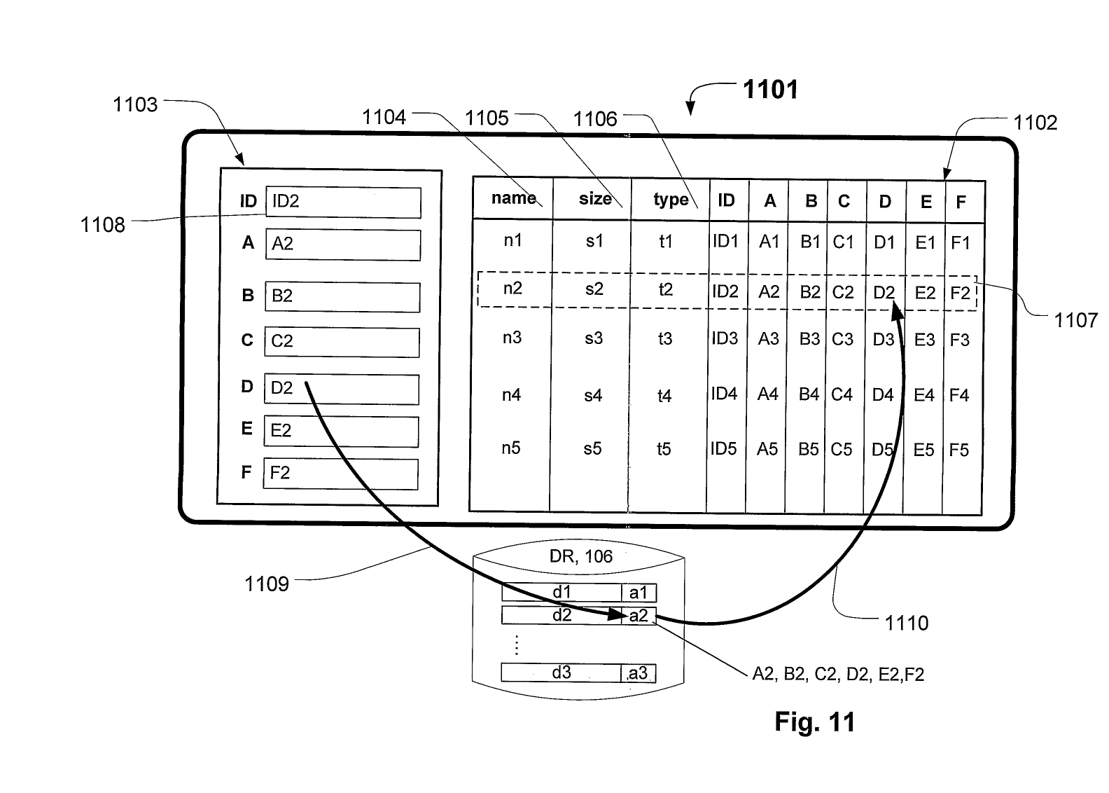

FIG. 10 illustrates how the method described in FIGS. 6 and 7 could be implemented in a document management system. First, the DMS finds/locates a document (1001) stored in a document repository (106). This could be done either by a user browsing the document repository or by an automatic search performed by the DMS. Once a document has been found the DMS determines if the document has additional attributes associated (1003). If the document does not have any additional attributes associated the user can create (1005) and store (1007) the additional attributes as described in FIG. 8. If the document has additional attributed associated the DMS would read the attributes (1009) as described in FIG. 9. If DMS is embodied comprising a GUI the attributes could be displayed on a screen (1011). When the attributes have been read and displayed the user can choose (1013) different opportunities in order to handle the attributes. The user could delete the attributes associated to the document (1015). This is possible since the attributes are stored as an attached part to the document and can therefore be removed without destroying the document. In a NTFS system this could be done by deleting contents of the alternate data stream attached to the document. The user can edit the existing attributes (1017); this is done by replacing the existing additional attributes with the new attributes. The DMS could also allow the user to add extra attributes (1019) to the document which could be useful if the user needs extra attributes.

FIG. 11 illustrates an embodiment of the editing interface according to the present invention. The editing interface constitutes the user interface of the document management system and is implemented as a graphical user interface displayed on a screen. The user can operate the DMS by using different input devices such as a keyboard, touch screen, mouse, etc. The graphical user interface (1101) comprises a first part as a document window (1102), and a second part as an attribute window (1103). The document window shows the documents stored in a document repository (106), and this is done by showing basic document information such as document name (1104), size of document (1105) and document type (1106). The basic information is in a file system typically stored in a file master table in order to make it possible for the operating system to handle the file. The amount of information which can be stored in the file master table is limited, and the document management system therefore stores additional attributes as an additional part of the document as described in FIG. 1. The GUI is adapted to retrieve the additional attributes stored as an additional part of the document and show the attributes (ID, A, B, C, E, F) together with the document's basic information in the document window. For instance the second document from the top of the figure has the basic information: name n2; size s2; and type t2; and the additional attributes ID2, A2, B2, C2, D2, E2 and F2.

The attribute window (1103) shows the additional attributes added to the document highlighted/marked (1107) in the document window. The attributes are each shown in a display box (1108) and could e.g. be an ID number (ID), the author of the document (A), a billing code (B), a costumer number (C), a description of the document (D), the status of the document (E), the documents history (F), etc. The type and number of attributes added to a document depends on the user's requirements to the attributes needed to handle the documents. In the figure the second document from the top is highlighted/marked, and the additional attributes associated to this document are therefore shown in the different display boxes in the attribute window.

In the present embodiment the display boxes are carried out as entry forms that both show the additional attributes and allow the user to edit the attributes. The user chooses which attribute he/she wants to edit, and thereafter a cursor appears in the display box showing the attribute where after the user can edit the attribute for instance by using a keyboard. When a user edits an attribute in a display box the document management system would update the attributes stored in the document repository and thereafter update the document window so that it shows the new attribute. For instance when a user is editing attribute (D) associated to the highlighted/marked document (1107), the DMS would store the changes in the attribute made by the user as indicated with arrow (1109) and thereafter update the document window as indicated with arrow (1110).

The attribute window could furthermore be used as a search window where the user is able to enter search criteria in the different attributes in order to perform a search in the document attributes. The DMS would perform the search defined by the user and thereafter display the matching documents in the document window. Thereafter the user can choose to further specify the search criteria, perform a new search, browse or edit the matching documents.

The GUI could be embodied in many different ways, and a person skilled in the art would be able to construct a number of different GUI depending on the design and opportunities.

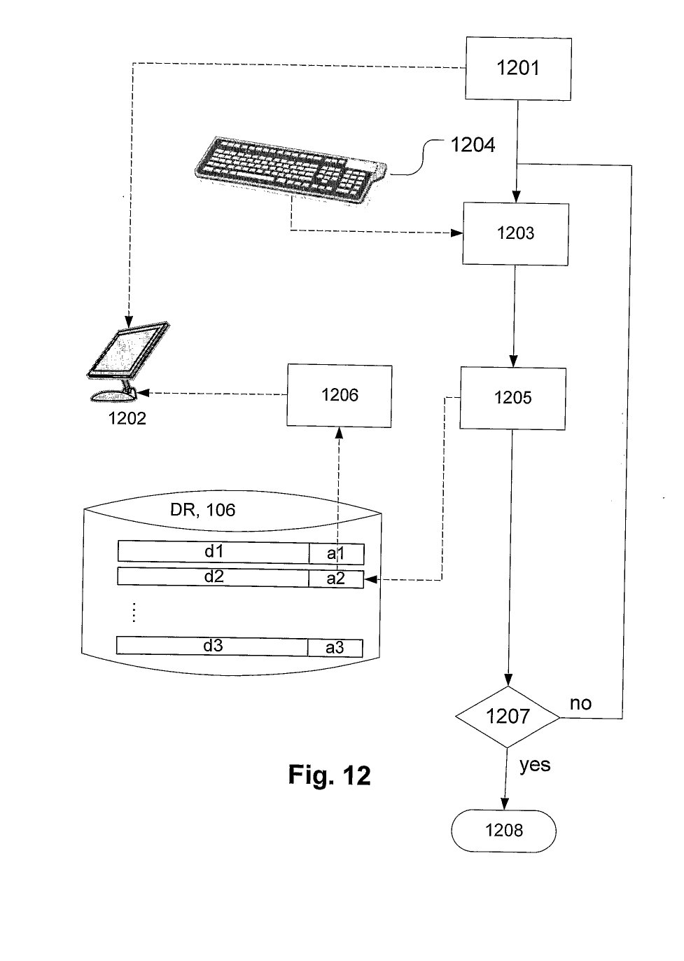

FIG. 12 illustrates a flow diagram of the editing method run by the DMS when a user edits an attribute shown in a display box in FIG. 11. First the user finds and highlights a document displayed in the document window and the DMS would show the additional attributes in the attributes window (1201) on a screen (1202). Thereafter the user edits an attribute (1203) for instance by entering new information into an attributes display box using a keyboard (1204). When the user has finished editing the attributes, the DMS stores the changes in the document repository (1205). The DMS would immediately after the changes have been stored update the GUI (1206), so that the changes are shown in the document window. Thereafter it is tested (1207) if the user has stopped editing the attributes. The method is restarted at step (1203), if the user is still editing attributes whereas the method is brought and end (1208) if the user is done editing the attributes. The editing process could be adapted to store the changes just as the user has typed one character. That means that the storing process (1205) would start just as the user has entered new information (1203) for instance after each character. In another embodiment of the editing method the storing process (1205) could be adapted to wait until the user has finished editing the attributes. The consequence of this embodiment is that the document window would show stored data whereas the attribute window would show unsaved data.

The above-described methods can be implemented in many different ways by a person skilled in the art, and the methods should therefore only serve as an example and not limit the present invention.

1. A method of storing attributes describing documents in a document management system software application which is configured to be run on a computer with an operating system and a file system, wherein the documents to be managed are stored in said file system and said documents are described by attributes such as identifiers and properties characterized in that the attributes are stored as separate elements attached to said documents.

2. A method according to claim 1 wherein the file system is configured to maintain a master file table of electronic files stored by means of the file system; said electronic files comprising a primary data stream and an alternate data stream; said electronic files comprising documents, said storing of said attributes is performed by using said alternate data stream as a repository.

3. A method according to claim 1 where the file system is the New Technology File System, NTFS, manufactured by Microsoft Corporation®.

4. A method according to claim 1 where the operating system is a Windows operating system manufactured by Microsoft Corporation®.

5. A method according to claim 1 wherein the attributes are attached to the documents by encapsulating the document and the attributes in a single file.

6. A method according to claim 5 wherein the file is a XML file.

7. A method according to claim 1 wherein the attributes are attached to said document as a separate file by a mapping in the file system.

8. A document management system software application which is configured to be run on a computer with an operating system and a file system, wherein the document management system is for managing documents stored in said file system, wherein said documents are described by attributes such as identifiers and properties characterized in that the document management system is configured to handle document attributes being separately and directly attached to said documents.

9. A document management system according to claim 8 where the file system is the New Technology File System, NTFS, manufactured by Microsoft Corporation®.

10. A document management system according to claim 8 where the operating system is a Windows operating system manufactured by Microsoft Corporation®.

11. A document management system software application according to claim 8 characterized in that the document management system comprises an editing interface comprising a first part for viewing the document attributes of the documents handled by the document management system and selecting a document and a second part for editing attributes of said selected document.

12. A document management system according to claim 11, wherein it is the attached attributes that can be edited from said second part of said editing interface.

13. A document management system according to claim 11, wherein the file system is configured to maintain a master file table of electronic files stored by means of the file system; said electronic files comprising a primary data stream and an alternate data stream; said electronic files comprising documents; said storing of said attributes is performed by using said alternate data stream as a repository and wherein it is the attributes in said alternate data stream that can be edited from said second part of said editing interface.

14. A document management system according to claim 11, wherein the attributes relating to said documents are updated immediately after editing the attribute from said second part of said editing interface.

15. A document management system according to claim 11, wherein the attributes relating to said documents are updated periodically at predefined time intervals after editing the attributes from said second part of said editing interface.

16. A document management system according to claim 11, wherein the editing interface further comprises a third part for searching for documents in said document managing system based on said related attributes.
